(19) United States
(12) Patent Application Publication
(10) Pub. No.: US 2005/0179272 A1
(43) Pub. Date: Aug. 18, 2005

(54) Oblong, non-slip, ergonomic handle for kitchen utensils

(75) Inventor: Fermin Miguel Santis Gonzalez, Santiago (CL)

Correspondence Address: D. Hochberg;D. Peter Hochberg Co., L.P.A., 6th Floor, 1940 East 6th St., Cleveland, OH, 44114, US

(73) Assignee: Virutex Ilko S.A.

(21) Appl. No.: 11/060,030

(22) Filed: Feb. 17, 2005

(30) Foreign Application Priority Data
Feb. 17, 2004 (CL) 0277-2004

(51) Int. Cl. A01D 9/00

(52) U.S. Cl. 294/49; 30/325

(57) ABSTRACT

An ergonomic, oblong handle for kitchen utensils such as a spatula, specially designed to provide more comfort and safety to users. The handle comprises two materials: a non-slip thermoplastic rubber and a plastic (resin).

Ergonomic, oblong handle for kitchen utensils such as a spatula, specially designed to provide more comfort and safety to users, and made of two materials, non-slip thermoplastic rubber, and plastic (resin).

### STATE OF THE ART

The closest to this patent application is the following, U.S. Pat. No. 2,457,394 published on Dec. 28, 1948 by Union Asbestos & Rubber Company titled “Handle for Kitchen Utensils”, patent No GB939488 published on Aug. 16, 1963 by Sundt & Company Ltd. titled “Safety Improvements for Kitchen Utensils, and like”, patent No JP51115561 published on Dec. 10, 1976 by Tsubasme Kanamono KK titled “Method to Manufacture a Screwable Handle for Kitchen Utensils”, patent No GB2208156 published on Mar. 8, 1989 by Arco Metal and Glassware Limit (GB), titled “Rubber, Oblong, Tapered Hole for Hanging Storage Handle”, patent No WO9926516 published on Jun. 3, 1999 by David F. Dalury (US) and Griptech Inc. (US), titled “Ergonomic Handle for Hammer”, patent No EP0742083 published on Nov. 13, 1996 by Leifheit AG. (DE), titled “Soft Rubber, Fingerprint, and Tapered Hole for Hanging Storage Handle”, patent No DE10142921 published on Mar. 20, 2003 by Heinrich Helms (DE), titled “Daily Use Handle for Hand Tools and Kitchen Utensils, with Right-handed and Left-handed Fingerprints”. The following patent applications were also found, “kitchen utensil” belonging to FABRICADOS INOXIDABLES, S.A., No U200302129, application date Sep. 23, 2003; “handle with exchangeable kitchen utensils” belonging to DART INDUSTRIES INC., No E98115447, application date Aug. 17, 1998, and “ergonomic handle for kitchen utensil” belonging to TERRAILLON, No E88420304, application date Sep. 8, 1988.

### DESCRIPTION OF THE INVENTION

Oblong handle for kitchen utensils like the spatula, including two non-skip material areas providing more safety to users.

Its top view shows a straight axis, with an upper part, which is ovoid and oblong, fitted with a metallic, oblong part (eliminar esta parte); its sides are increasingly narrower to form a slightly narrower center; at the end close to the metallic part there is a recess to rest the thumb finger. Past the center, the handle growths forming an oblong ovoid, thicker than the upper part (no tiene espesor o anchura mayor que la parte superior).

As per its top view, it shows an ovoidal hole to hang the utensil.

As per its side view, the handle axis is bent.

The soft, thermoplastic, non-skid rubber covers the bottom part and ends up in a plane diagonal to the straight axis running to the rear part, from right to left; such plane covers the bottom and upper parts. This material is also found in the recess to rest the thumb finger.

The plastic material is next to such plane, diagonal to the upper part. In addition to the tapered hole for hanging storage.

### DESCRIPTION OF THE DRAWINGS

FIG. 1 shows an ergonomic utensil handle, composed of a thermoplastic, non-skid rubber part (1) a plastic or resin part (2), a recess for the thumb finger (3) made of non-skid material, the metallic part of the utensil (4), and the pass-through ovoidal hole (6) for hanging storage, in plastic or resin.

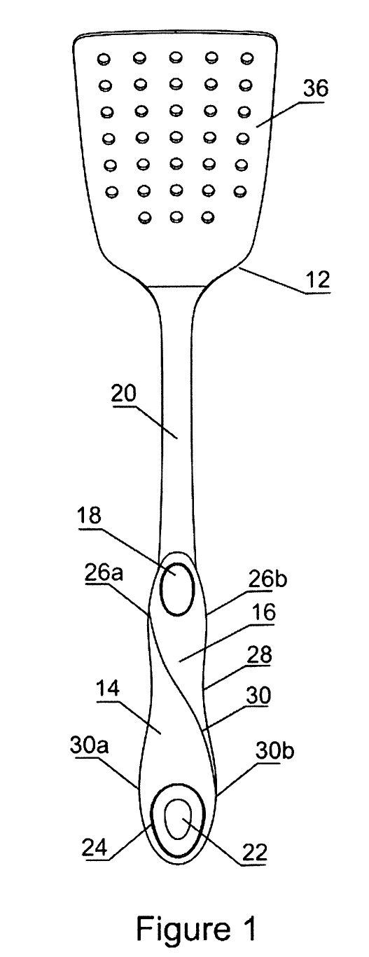

FIG. 2 is a side view from the left of the handle in FIG. 1, showing its bent shape, and the arrangement of the rubber part (1), a plastic part (2), a recess (3) for the thumb finger and the utensil rubber part (4), and the pass-through ovoidal hole (6) for hanging storage.

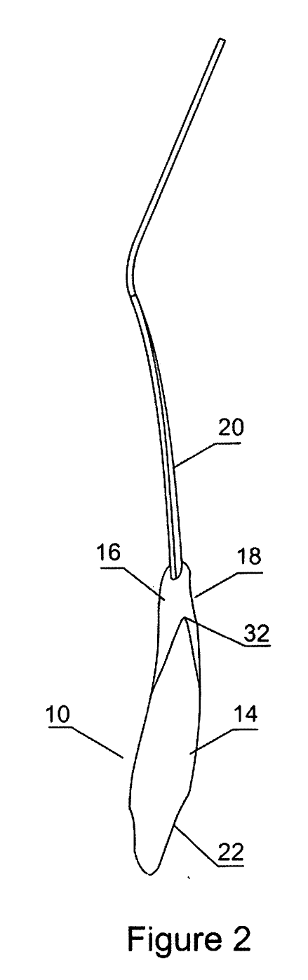

FIG. 3 is a side view from the left of the handle in FIG. 1, to show the arrangement of the components such as the thermoplastic, non-skid rubber (1), a plastic part (2), a thermoplastic, non-skid recess (3) for the thumb finger, and the utensil metallic part (4), and the pass-through ovoidal hole (6) for hanging storage.

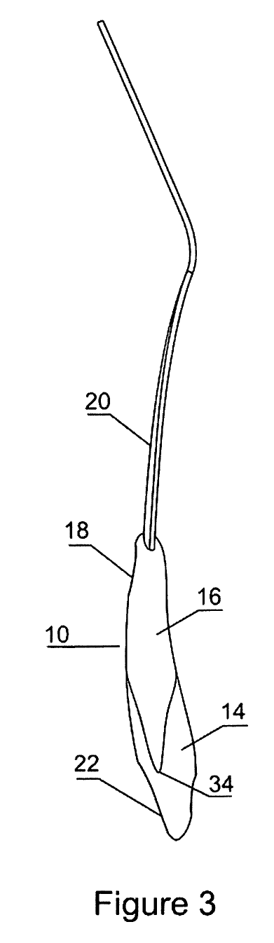

1. (canceled)

2. An oblong handle having a lengthwise vertical axis for kitchen utensils comprising:
at least two areas of non-skid material providing more safety to users, said at least two areas comprising:
an oblong, ovoidal upper portion having tapered sides comprising a non-skid material selected from the group consisting of plastic and resin; and
an oblong, ovoidal lower portion having tapered sides comprising a soft, thermoplastic, non-skid rubber material;
wherein a center portion is between said upper portion and said lower portion, said tapered sides of said upper portion are progressively narrowed downwardly until merging with said center portion and said tapered sides of said lower portion are progressively narrowed upwardly until merging with said center portion and wherein a part of said upper portion and a part of said lower portion each form said center portion; and
a recess on said upper portion for accommodating the thumb of a user;
wherein a plane/division extends through said handle substantially diagonal relative to said vertical axis and separates said soft, thermoplastic non-skid rubber material from said material selected from the group consisting of plastic and resin, and wherein said rubber material forms said lower portion extending upwardly to said plane/division and said material selected from the group consisting of plastic and resin forms said upper portion extending downwardly to said plane/division.

3. The handle according to claim 2, wherein said upper portion is fitted with a metallic oblong part.

4. The handle according to claim 2, and further comprising an annular edge defining a hole on said lower portion, said annular edge comprising a material selected from the group consisting of plastic and resin for hanging said handle.

5. The handle according to claim 4, wherein said material of said annular edge for defining said hole is the same material of said upper portion.

6. The handle according to claim 2, wherein said lower portion is thicker than said upper portion.

7. The handle according to claim 2, wherein said substantially diagonal plane/division extends in a substantially upwardly direction from the right side of said handle to the left side of said handle.

8. The handle according to claim 2, wherein said plane/division partially covers said upper and lower portions.

9. The handle according to claim 2, wherein said recess comprises the same material as said lower portion.

10. The handle according to claim 9, wherein said recess comprises a soft, thermoplastic non-skid rubber material.

11. The handle according to claim 2, wherein said handle is bent relative to said vertical axis.

12. A handle for a utensil or tool, said handle having a front portion when viewed facing the front of the working element of the utensil or tool, a central longitudinal axis, a central plane perpendicular to said front portion and including the central longitudinal axis, a right side and a left side, and said handle comprising;
an ovoidal shaped free portion having a free end;
an ovoidal shaped connection portion having a connecting end for connecting with the working element of the utensil or tool:
wherein said ovoidal shaped free portion has its widest portion perpendicular to said central plane and adjacent said free end, said ovoidal shaped connecting portion has its widest part perpendicular to said central plane and adjacent said connecting end, said ovoidal shape free portion and said ovoidal shaped connecting portion meeting at an ovoidal edge extending from the right side of said handle adjacent said free end, extending across the center of said handle to the right side of said handle adjacent said connecting end.

13. A handle according to claim 12 wherein said handle is bent forward in the central plane.

14. A handle according to claim 12 wherein a thumb recess is provided in said connecting portion adjacent said connecting end.

15. A handle according to claim 12 wherein a hole extends through said handle along said central plane and adjacent said free end.

16. A handle according to claim 12 wherein the narrowest part of said handle measured perpendicular to said central plane is near the longitudinal center of said handle.
